(19) United States
(12) Patent Application Publication
(10) Pub. No.: US 2011/0183213 A1
(43) Pub. Date: Jul. 28, 2011

(54) LITHIUM ION BATTERY

(75) Inventors: Ryo INOUE, Hitachinaka (JP); Takefumi OKUMURA, Hitachinaka (JP)

(73) Assignee: Hitachi, Ltd.

(21) Appl. No.: 13/004,161

(22) Filed: Jan. 11, 2011

(30) Foreign Application Priority Data
Jan. 22, 2010 (JP) 2010-011892

(51) Int. Cl. H01M 10/056

(52) U.S. Cl. 429/324; 429/330; 429/331; 429/332

(57) ABSTRACT

An object of the present invention is to provide a lithium ion battery in which the deterioration during the high temperature storage is suppressed. The lithium ion battery is a lithium ion battery 100 having a cathode 3 capable of occluding and releasing lithium ions, an anode 6 capable of occluding and releasing lithium ions, a separator 7 disposed between the cathode 3 and the anode 6 and an organic electrolyte solution, wherein the organic electrolyte solution contains a plurality of solvents, an additive and an electrolyte, the electrolyte contains lithium hexafluorophosphate (LiPF₆), and the additive contains vinylene carbonate or a derivative thereof and a compound represented by the following formula (I):

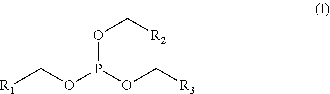

wherein R₁, R₂ and R₃ are each independently a fluorine atom or a fluorinated alkyl group having 1 to 3 carbon atoms.

### BACKGROUND OF THE INVENTION

1. Field of the Invention

The present invention relates to a lithium ion battery having a cathode capable of occluding and releasing lithium ions, an anode capable of occluding and releasing lithium ions, a separator disposed between the cathode and the anode and an organic electrolyte solution.

2. Background Art

From the viewpoint of environmental protection and energy saving, a hybrid electric vehicle (HEV) combining an engine and a motor as a power source has been developed and commercialized. In addition, a plug-in hybrid electric vehicle (PHEV) capable of supplying electric power from an electric plug is going to be developed in the future. A secondary battery repeatedly capable of charging and discharging electricity is used for the power source of the hybrid electric vehicle. Above all, a lithium ion battery is advantageous in that it has high operating voltage compared to other secondary batteries such as a nickel hydrogen battery, making it possible to easily obtain high output power, and in the future, it is considered that the importance of the lithium ion battery as the power source of the hybrid electric vehicle is increasingly significant.

A lithium ion battery for a hybrid electric vehicle generally consists of a cathode composed of a lithium-containing transition metal complex oxide such as LiCoO₂, LiNiO₂, LiMn₂O₄ and LiFeO₂, an anode composed of graphite or the like, a separator disposed between the cathode and the anode, and an electrolyte solution containing a solvent, an additive and an electrolyte.

As the electrolyte in a lithium ion battery, there is used an electrolyte which is prepared by dissolving a lithium salt such as lithium tetrafluoroborate (LiBF₄) and lithium hexafluorophosphate (LiPF₆). Among them, LiPF₆ having a high conductivity is frequently used as a main component of the electrolyte.

However, when LiPF₆ is used, during the production or use of the secondary battery, a minute amount of water which is present in the battery or goes into the battery is reacted with LiPF₆ to generate hydrogen fluoride (HF). Specifically, LiPF₆ is dissociated by heat (LiPF₆→LiF+PF₅), whereby the resulting PF₅ is reacted with water to generate HF. The HF dissolves and erodes a battery container or a metal material of a collector, and further dissolves a cathode active substance to elute a transition metal. Further, it is known that a solid electrolyte interface (SEI) layer which is an inactive coating film containing a metal is formed on the surface of an anode active substance to inhibit the action of a Li⁺ ion, thereby deteriorating the battery. Such deterioration of battery characteristics occurs even when a slight thermal decomposition of LiPF₆ occurs in the electrolyte, and further, a significant deterioration occurs during the long term storage or continuous charging and discharging of the battery. This deterioration is a fatal flaw of the secondary battery. As the causes of the deterioration of a lithium ion battery, there are two modes, deterioration of storage characteristics and deterioration of continuous charging and discharging characteristics. The deterioration of storage characteristics is a deterioration which occurs in the battery in a charging state and depends on the charging amount. On the other hand, the deterioration of continuous charging and discharging characteristics is a deterioration which is caused by repeating the charging and discharging cycles and depends on the number of cycles. Therefore, methods of preventing the deterioration in the deterioration of storage characteristics and deterioration of continuous charging and discharging characteristics are individually different. In this manner, when LiPF₆ is used as an electrolyte, there was a problem that a side reaction adversely affecting the constituent material in the battery is likely to occur under a high temperature environment.

Consequently, in a lithium ion battery, in order to prevent the deterioration due to HF which is generated during the long term storage or continuous charging and discharging of the battery, various additives have been tried to be added into the electrolyte solution. For example, JP Patent Publication (Kokai) No. 9-245832 A (1997) proposes a technique in which 1,4,8,11-tetraazacyclotetradecane (TACTD) is added into an electrolyte solution to neutralize and remove HF generated by the thermal decomposition of LiPF₆. The relationship between the capacity of the battery and the number of charging and discharging cycles is shown, and the capacity deterioration of the battery due to charging and discharging cycles is considered to be prevented by adding an appropriate amount of TACTD, thereby enabling improvement in the storage characteristics.

JP Patent Publication (Kokai) No. 2003-297424 A suggests that N-methyl-2-pyrrolidone (NMP) is added to a non-aqueous electrolyte to reduce the amount of a gas generated during the thermal decomposition of the electrolyte solution, thereby enabling the suppression of the deterioration of the battery characteristics due to high temperature storage. In addition, the Journal of The Electrochemical Society, 151 (10), A1659-A1669 (2004) investigates the relationship between the composition of the electrolyte and the storage characteristics and suggests that vinylene carbonate (VC) is added in an amount of 2% by weight to an electrolyte solution composed of LiPF₆, EC and DMC, thereby enabling the suppression of the deterioration of the battery under a high temperature environment at 60° C.

JP Patent Publication (Kokai) No. 2006-24440 A discloses a lithium battery having a cross-linked polymer electrolyte composition containing an additive composed of a polyether multielement polymer, an aprotic organic solvent and a phosphorus-containing compound and an electrolyte compound composed of a lithium salt compound.

### SUMMARY OF THE INVENTION

However, in the method of JP Patent Publication (Kokai) No. 9-245832A (1997), HF is generated again as long as water and PF₅ generated by the dissociation of LiPF₆ are present, and it is concerned that the amount of HF in the organic electrolyte solution is again increased with the lapse of time.

In addition, the battery during charging and discharging has an extremely strong reducing action in the vicinity of the anode surface and has a strong oxidizing action in the vicinity of the cathode. Therefore, examples of the problem of the secondary battery include the deterioration of the battery due to the deterioration reaction such as the decomposition of the electrolyte solution and the electrolyte on these electrode surfaces. There was a problem that the battery capacity is decreased due to the deterioration reaction and especially the deterioration reaction is accelerated under a high temperature environment. In the method of JP Patent Publication (Kokai) No. 2003-297424 A, NMP causes a side reaction with the cathode because it has a low oxidation resistance, and it is concerned that the internal resistance of the battery is increased, causing the deterioration of the battery.

JP Patent Publication (Kokai) No. 2006-24440 A does not describe the battery capacity, battery resistance and output power as the high temperature storage characteristics. In addition, from the viewpoint of improving safety, since the technique of this publication uses a polymer electrolyte prepared by gelling an organic electrolyte solution with a polyether multielement polymer, the ion conductivity is decreased compared with the conventional organic electrolyte solution and the adhesiveness in the interface between the electrode and the polymer electrolyte is reduced, thereby reducing the battery performance. Further, the presence or absence of the polyether multielement polymer causes the difference in effect on the battery characteristics of the electrolyte solution and also greatly influences the battery design parameters. As a result of studies, the present inventors have found that a stable coating film is not formed in the interface between the electrode and the electrolyte, and the coating film has no effect on suppressing a side reaction between the electrode and the electrolyte under a high temperature environment and inversely the internal resistance of the battery is increased by a side reaction product, depending on the combination of an aprotic organic solvent and a phosphite ester compound. Therefore, the type and amount of the additive incorporated in the electrolyte solution are very important and it is essential to specify the type and amount of the additive depending on the solvent in the electrolyte solution.

Further, in Journal of The Electrochemical Society, 151 (10), A1659-A1669 (2004), by use of an additive composed of vinylene carbonate (VC), the life of the battery was significantly increased under a high temperature environment compared to the conventional one, but the storage performance of the battery capacity was insufficient.

Under these circumstances, an object of the present invention is to provide a new lithium ion battery which can solve the above problems. In particular, the present invention can provide a lithium ion battery in which the deterioration during storage at a high temperature can be suppressed.

The present inventors have found that a phosphorus compound such as tris(2,2,2-trifluoroethyl)phosphite (TTFP) used as an additive is effective for trapping PF₅ generated by thermal decomposition of LiPF₆, and further that the electrode reaction on the anode surface can be suppressed and the deterioration of the battery capacity and the internal resistance under a high temperature environment can be suppressed by adding vinylene carbonate or a derivative thereof as an additive, and have completed the present invention. That is, the gist of the present invention is as follows.

(1) A lithium ion battery having a cathode capable of occluding and releasing lithium ions, an anode capable of occluding and releasing lithium ions, a separator disposed between the cathode and the anode and an organic electrolyte solution, wherein the organic electrolyte solution contains a plurality of solvents, an additive and an electrolyte, the electrolyte contains lithium hexafluorophosphate (LiPF₆), and the additive contains vinylene carbonate or a derivative thereof and a compound represented by the following formula (I):

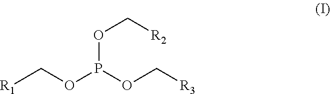

wherein R₁, R₂ and R₃ are each independently a fluorine atom or a fluorinated alkyl group having 1 to 3 carbon atoms.

(2) The lithium ion battery according to the above (1), wherein the solvent contains a cyclic carbonate represented by the following formula (II):

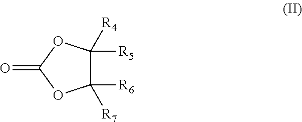

wherein R₄, R₅, R₆ and R₇ are each independently a hydrogen atom or an alkyl group having 1 to 3 carbon atoms
and a chain carbonate represented by the following formula (III):

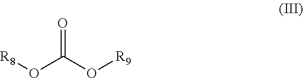

wherein R₈ and R₉ are each independently a hydrogen atom or an alkyl group having 1 to 3 carbon atoms.

(3) The lithium ion battery according to the above (2), wherein the cyclic carbonate is at least one selected from ethylene carbonate and propylene carbonate, and the chain carbonate is at least one selected from dimethyl carbonate and ethyl methyl carbonate.

(4) The lithium ion battery according to the above (3), wherein the cyclic carbonate is ethylene carbonate and the chain carbonate is dimethyl carbonate and ethyl methyl carbonate.

(5) The lithium ion battery according to any one of the above (1) to (4), wherein the compound represented by the formula (I) is tris(2,2,2-trifluoroethyl)phosphite (TTFP).

(6) The lithium ion battery according to any one of the above (1) to (5), wherein the content ratio of the compound represented by the formula (I) is 0.01 parts by weight or more and 5.0 parts by weight or less, based on 100 parts by weight of the organic electrolyte solution.

(7) The lithium ion battery according to any one of the above (1) to (6), wherein the concentration of the electrolyte is 0.5 mol/l or more and 2.0 mol/l or less, based on the total amount of the solvent and the additive.

(8) The lithium ion battery according to any one of the above (1) to (7), wherein the cathode contains a lithium transition metal oxide represented by LiMnₓM1_{y}M2_{z}O₂, wherein M1 is at least one selected from Co and Ni, M2 is at least one selected from Co, Ni, Al, B, Fe, Mg and Cr, x+y+z=1, 0.2≦x≦0.6, 0.2≦y≦0.6 and 0.05≦z≦0.4).

According to the invention, in a lithium ion battery using an electrolyte in which lithium hexafluorophosphate (LiPF₆) is dissolved, the life of the lithium ion battery can be improved by forming a protection coating film on the anode surface to suppress the reaction between the electrolyte and the anode and suppress the deterioration during storage at a high temperature caused by the thermal decomposition of a lithium salt.

### BRIEF DESCRIPTION OF THE DRAWING

FIG. 1 is a partial cross-sectional pattern diagram showing a wound-type lithium ion battery which is one embodiment of the present invention.

### DESCRIPTION OF SYMBOLS

1 CATHODE COLLECTOR
2 CATHODE ELECTRODE LAYER
3 CATHODE
4 ANODE COLLECTOR
5 ANODE ELECTRODE LAYER
6 ANODE
7 SEPARATOR
8 CATHODE LEAD
9 ANODE LEAD
10 CATHODE INSULATOR
11 ANODE INSULATOR
12 CATHODE BATTERY COVER
13 ANODE BATTERY CAN
14 GASKET
100 LITHIUM ION BATTERY

### DETAILED DESCRIPTION OF THE PREFERRED EMBODIMENTS

Hereinafter, embodiments of a lithium ion battery according to the present invention will be described with reference to a drawing, but the present invention is not limited by these embodiments.

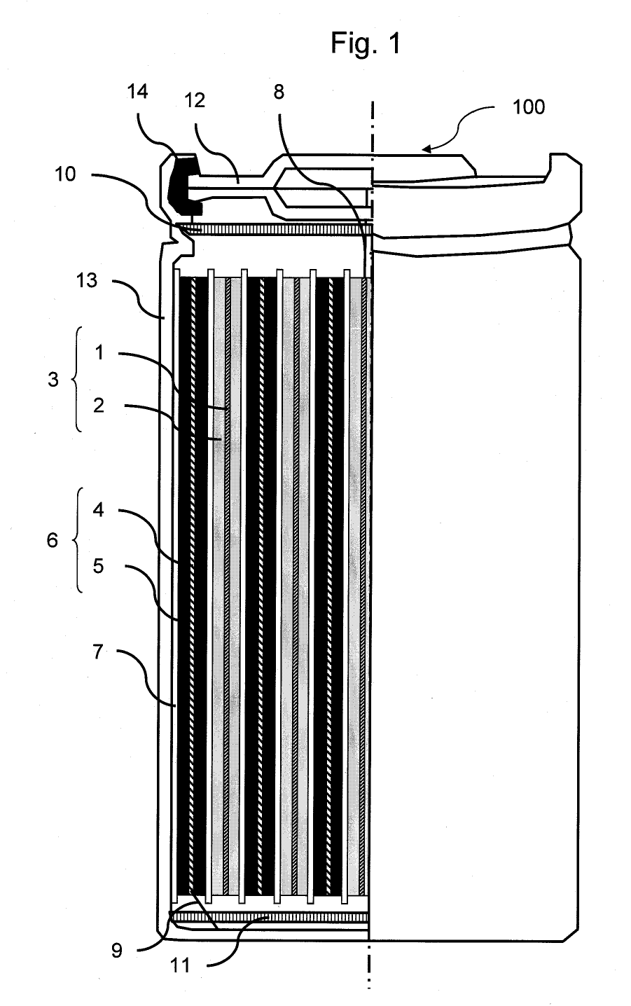

FIG. 1 is a partial cross-sectional pattern diagram showing a wound-type lithium ion battery which is one embodiment of a lithium ion battery of the present invention. The lithium ion battery 100 uses lithium as an electrode reacting substance. The lithium ion battery 100 is a so-called cylindrical type and has a wound electrode group in which a pair of belt-shaped cathode 3 and belt-shaped anode 6 and a separator 7 are wound in an almost hollow cylindrical anode battery can 13, the cathode 3 and the anode 6 are disposed oppositely to each other via the separator 7 and the can is filled with the electrolyte solution.

The anode battery can 13 is composed, for example, of iron (Fe) plated with nickel (Ni) in which one end is closed and the other end is opened. A pair of a cathode insulator 10 and an anode insulator 11 is individually disposed vertically to the wound periphery so as to sandwich the wound electrode group in the anode battery can 13.

A cathode battery cover 12 is attached to the open end portion of the anode battery can 13 by caulking through a gasket 14 and the inside of the anode battery can 13 is hermetically closed. The cathode battery cover 12 is composed, for example, of a material similar to that of the anode battery can 13.

A cathode lead 8, which is made, for example, of aluminum (Al) or the like, is connected to the cathode 3 of the wound electrode group, and an anode lead 9, which is made, for example, of nickel (Ni) or the like, is connected to the anode 6. The cathode lead 8 is electrically connected to the cathode battery cover 12, and the anode lead 9 is welded and electrically connected to the anode battery can 13.

Hereinafter, the cathode, the anode and the electrolyte solution in the battery will be described.

(Cathode)

Firstly, the cathode 3 is described. The cathode 3 can be obtained by applying a cathode material paste containing a cathode active substance, a conductive material, a binder and the like on the surface of a cathode collector 1. Specifically, in consideration of the solid content weight on drying, the cathode material paste is prepared from a cathode active substance, a conductive material such as graphite and a binder using a solvent. The cathode material paste is applied on an aluminum foil or the like which is used as the cathode collector 1 and then dried, for example, at 80° C. and pressed with a pressure roller, followed by drying at 120° C. to form a cathode electrode layer 2 on the cathode collector 1.

As the cathode active substance, preferably used is a substance represented by LiMnₓM1_{y}M2_{z}O₂, wherein M1 is at least one selected from Co and Ni, M2 is at least one selected from Co, Ni, Al, B, Fe, Mg and Cr, x+y+z=1, 0.2≦x≦0.6, 0.2≦y≦0.6 and 0.05≦z≦0.4.

Above all, preferably used are LiMn_{0.4}Ni_{0.4}Co_{0.2}O₂, LiMn_{1/3}Ni_{1/3}Co_{1/3}O₂, LiMn_{0.3}Ni_{0.4}Co_{0.3}O₂, LiMn_{0.35}Ni_{0.3}Co_{0.3}Al_{0.05}O₂, LiMn_{0.35}Ni_{0.3}Co_{0.3}B_{0.05}O₂, LiMn_{0.35}Ni_{0.3}Co_{0.3}Fe_{0.05}O₂, LiMn_{0.35}Ni_{0.3}Co_{0.3}Mg_{0.05}O₂, and the like. In addition, if the content of Ni is increased in the composition, the battery capacity is increased, or if the content of Co is increased, the output power at a low temperature is increased, or if the content of Mn is increased, the material cost can be suppressed. In particular, LiMn_{1/3}Ni_{1/3}Co_{1/3}O₂ is excellent in low-temperature characteristics and cycle stability and is appropriate as a lithium ion battery material for a hybrid electric vehicle (HEV). In addition to the above, there may be used an orthorhombic phosphate compound having a symmetry property of a space group Pₙₘₐ, which is represented by the general formula, LiMₓPO₄, wherein M is Fe or Mn and 0.01≦x≦0.4, or LiMn₁₋ₓMₓPO₄, wherein M is a bivalent cation other than Mn and 0.01≦x≦0.04.

Any cathode binder may be used as long as it can tightly bond a material comprising a cathode and a collector for a cathode, and examples of the cathode binder include a homopolymer or a copolymer of vinylidene fluoride, ethylene tetrafluoride, acrylonitrile, ethylene oxide and the like, or a styrene-butadiene rubber and the like.

As the conductive material, there may be used a carbon material such as carbon black, graphite, carbon fiber and metal carbide. These may be used alone or by mixing two or more kinds.

(Anode)

Subsequently, the anode 6 will be described. The anode 6 can be obtained by applying an anode material paste obtained by mixing an anode active substance, a conductive material, a binder and the like onto the surface of an anode collector 4 to form an anode electrode layer 5. Specifically, in consideration of the solid content weight on drying, the anode material paste is prepared from an anode active substance, a conductive material and a binder using a solvent. The anode material paste is applied onto a copper foil or the like which is used as the anode collector 4 and then dried, for example, at 80° C. and pressed with a pressure roller, followed by drying at 120° C. to form an anode electrode layer 5 on the anode collector 4.

As the anode active substance, there can be used natural graphite, a composite carbonaceous material in which a coating film is formed on natural graphite by a dry CVD (Chemical Vapor Deposition) method or a wet spray method, artificial graphite produced by calcining a resin material such as epoxy or phenol resin or a pitch type material obtained from petroleum or coal as a raw material, a carbonaceous material such as an amorphous carbon material, a metal capable of occluding and releasing lithium by forming a compound with lithium, silicon capable of occluding and releasing lithium by forming a compound with lithium to be inserted into crystal pores, and an oxide or a nitride of a group IV element such as germanium (Ge) or tin (Sn). In particular, from the viewpoint of high conductivity, low temperature characteristics and cycle stability, a carbonaceous material is an excellent material. Among the carbonaceous materials, a material having wide carbon interplanar spacing (d₀₀₂) is preferable because it has an excellent performance in rapid charge/discharge characteristics and is excellent in low temperature characteristics. However, since a material having wide d₀₀₂ may cause the capacity deterioration at the initial stage of charging or may decrease charging and discharging efficiency, d₀₀₂ is preferably 0.39 nm or less. Such a carbonaceous material may be referred to as a pseudo-anisotropic carbon. Further, in order to constitute an anode, a carbonaceous material having a high conductivity such as graphite, an amorphous carbon material or activated carbon, as described above, may be mixed and used.

Any anode binder may be used so long as it can tightly bond a material comprising an anode and a collector for an anode, and examples of the anode binder include a homopolymer or a copolymer of vinylidene fluoride, ethylene tetrafluoride, acrylonitrile, ethylene oxide and the like, or a styrene-butadiene rubber and the like.

As the conductive material, there may be used a carbon material such as carbon black, graphite, carbon fiber and metal carbide. These may be used alone or by mixing two or more kinds.

(Electrolyte Solution)

Next, the electrolyte solution is described. The electrolyte solution is mainly composed of a solvent, an additive and an electrolyte. An electrolyte solution for a lithium ion battery, which in principle can be operated in a wide range of voltage, is required to have high voltage resistance. Therefore, an organic electrolyte solution using an organic compound as a solvent is used. In particular, an organic electrolyte solution which contains a lithium salt as an electrolyte and a carbonate as a solvent is preferably used as an electrolyte solution for a lithium ion battery in that it has a high conductivity and has a wide potential window.

An electrolyte solution containing a lithium salt and a carbonate-based solvent is known to react on the anode surface of a lithium ion battery. In order to obtain a battery suppressing these reactions and having high resistance against long-term storage and continuous charging and discharging of the battery, there are added additives having a reduction reaction potential higher than that of a solvent to an electrolyte solution. These additives themselves are reduced and decomposed to form an inactive coating film (SEI) on the anode surface. And then, the coating film formed on the anode surface suppresses the continuous electrode reaction. On the other hand, it is known that SEI inhibits the action of lithium⁺ ions and deteriorates the battery. For this reason, it is important to select an additive so that SEI which does not inhibit the action of lithium⁺ ions is formed.

As the electrolyte, lithium hexafluorophosphate (LiPF₆) is preferable because it has a high quality stability and a high ion conductivity in a carbonate solvent. The concentration of the electrolyte is preferably 0.5 mol/l or more and 2.0 mol/l or less, based on the total amount of the solvent and the additive. If the concentration of the electrolyte is too low, the electric conductivity of the organic electrolyte solution may be insufficient, and conversely, if the concentration is too high, the electric conductivity is rather decreased because of the increase in viscosity of the organic electrolyte solution and the performance of the lithium ion battery may be reduced.

Examples of the solvent used include an aprotic organic solvent such as ethylene carbonate (EC), dimethyl carbonate (DMC) and propylene carbonate or a mixed solvent of two or more kinds thereof. However, in the lithium ion battery, it is desired, for example, that the discharging characteristics during the charging and discharging cycles and the discharging characteristics at the time of low temperature and high current discharging be good, or the capacity storage characteristics during long-term storage or long-term high temperature storage be good, and an organic electrolyte solution which satisfies these characteristics is demanded. From these viewpoints, in the present invention, a solvent composed of a single compound is not used, but a plurality of compounds are mixed and used as a solvent.

Specifically, as the solvent, preferably used is a mixed solvent containing a cyclic carbonate represented by the following formula (II):

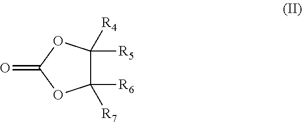

wherein R₄, R₅, R₆ and R₇ are each independently a hydrogen atom or an alkyl group having 1 to 3 carbon atoms
and a chain carbonate represented by the following formula (III):

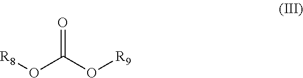

wherein R₈ and R₉ are each independently a hydrogen atom or an alkyl group having 1 to 3 carbon atoms. The mixing ratio between the cyclic carbonate and the chain carbonate varies depending on the type of each solvent and is not particularly limited, but generally preferably is cyclic carbonate:chain carbonate=18:82 to 30:70 (by volume ratio).

From the viewpoint of increasing the degree of dissociation of a lithium salt and improving the ion conductivity, as the cyclic carbonate of the formula (II), preferably used is at least one selected from, for example, ethylene carbonate (EC), propylene carbonate (PC), butylene carbonate (BC) and the like. EC is especially preferable because it has the highest permittivity and can increase the degree of dissociation of a lithium salt, thereby enabling the provision of an electrolyte solution having a high ion conductivity.

In addition, examples of the chain carbonate of the formula (III) include at least one selected from dimethyl carbonate (DMC), ethyl methyl carbonate (EMC), diethyl carbonate (DEC), methyl propyl carbonate (MPC), ethyl propyl carbonate (EPC) and the like.

In particular, DMC is a solvent having a high compatibility and is suitably used after mixing with EC and the like. DEC has a lower melting point than DMC and is suitably used in order to improve the low temperature characteristics at −30° C. Since EMC is asymmetric in structure and has a low melting point, as with DEC, it is suitably used in order to improve the low temperature characteristics. Among them, a mixed solvent combining EC and DMC is especially preferable because the battery characteristics can be maintained in a wide range of temperature.

The additive is used by combining vinylene carbonate or a derivative thereof and a phosphorus compound represented by the following formula (I):

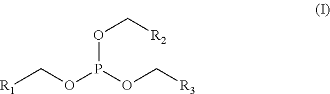

wherein R₁, R₂ and R₃ are each independently a fluorine atom or a fluorinated alkyl group having 1 to 3 carbon atoms.

Vinylene carbonate or a derivative thereof has a function of suppressing the electrode reaction on the anode surface and suppressing the deterioration under a high temperature environment. Examples of such vinylene carbonate or a derivative thereof specifically include at least one selected from vinylene carbonate (VC), methylvinylene carbonate (MVC), dimethylvinylene carbonate (DMVC), ethylvinylene carbonate (EVC), diethylvinylene carbonate (DEVC) and the like. VC is especially preferable because it has a small molecular weight and can form a dense electrode coating film. The content ratio of vinylene carbonate or a derivative thereof is preferably 0.01 parts by weight or more and 5.0 parts by weight or less, and more preferably 0.1 parts by weight or more and 2 parts by weight or less, based on 100 parts by weight of the organic electrolyte solution. If the content ratio is high, the resistance of the organic electrolyte solution may be increased.

The compound represented by the formula (I) has a high reactivity because the phosphorus (P) atom has a lone pair, and is reactive with a component generated by the decomposition of LiPF₆. The example of such a phosphorus compound, which can trap PF₅ generated by the decomposition of LiPF₆, specifically includes tris(2,2,2-trifluoroethyl)phosphite (TTFP). In addition, there may be used tris(2,2,2-difluoroethyl)phosphite, tris(2,2,2-fluoroethyl)phosphite, tris(2-fluoroethyl-2-difluoroethyl-2-trifluoroethyl)phosphite and the like. The content ratio of the compound represented by the formula (I) is preferably 0.01 parts by weight or more and 5 parts by weight or less, and more preferably 0.1 parts by weight or more and 2 parts by weight or less, based on 100 parts by weight of the organic electrolyte solution. If the content ratio is high, the resistance of the electrolyte solution may be increased.

Table 1 shows the content of HF (ppm) in each electrolyte solution when stored for 14 days under an environment at 70° C. In Table 1, the electrolyte solution without addition of an additive is prepared by dissolving lithium salt LiPF₆ as an electrolyte in a mixed solvent prepared by mixing EC, DMC and EMC with a volume composition ratio of 20:40:40, in an amount of 1 mol/l. The electrolyte solution with addition of VC is prepared by dissolving lithium salt LiPF₆ as an electrolyte in a mixed solvent prepared by mixing EC, DMC and EMC with a volume composition ratio of 20:40:40, in an amount of 1 mol/l, and further adding VC in an amount of 0.8% by weight based on the total weight of the solution composed of the mixed solvent and lithium salt. The electrolyte solution with addition of TTFP is prepared by dissolving lithium salt LiPF₆ as an electrolyte in a mixed solvent prepared by mixing EC, DMC and EMC with a volume composition ratio of 20:40:40, in an amount of 1 mol/l and further adding TTFP in an amount of 0.8% by weight, based on the total weight of the solution composed of the mixed solvent and lithium salt.

TABLE 1

| | Amount of Additives | Amount of HF |
|---|---|---|
| Additives | (% by weight) | (ppm) |
| Without | — | 1900 |
| VC | 0.8 | 1732 |
| TTFP | 0.8 | 1082 |

From the results in table 1, it is understood that the increased amount of HF after storage of the electrolyte with addition of TTFP is less than that of the electrolyte without addition of TTFP. That is, it can be said that the HF-generating reaction is suppressed by TTFP. From this fact, it was demonstrated that the generation amount of HF can be suppressed by the addition of TTFP even when the electrolyte solution was stored for a long period of time under a high temperature environment. The cause that HF is generated is due to the fact that the water in the battery is reacted with PF₅ generated by the dissociation of LiPF₆. In the production process of the battery, although it is difficult to completely remove the water from the inside of the battery, since TTFP traps PF₅ generated by the dissociation of LiPF₆, the generation of HF can be suppressed even when water remains in the battery. Therefore, since the deterioration reaction under a high temperature is suppressed, a lithium ion battery excellent in high temperature characteristics can be obtained.

### EXAMPLES

In order to confirm the high temperature storage characteristics of a lithium ion battery according to the present invention, the following experiments were carried out.

### Example 1

A wound-type lithium ion battery as shown in FIG. 1 was prepared as follows. Firstly, a cathode material paste was prepared by using LiMn_{1/3}Ni_{1/3}Co_{1/3}O₂ as a cathode active substance, carbon black (CB1) and graphite (GF1) as a conductive material, polyvinylidene fluoride (PVDF) as a binder and NMP (N-methylpyrrolidone) as a solvent so that the solid content weight on drying of LiMn_{1/3}Ni_{1/3}Co_{1/3}O₂:CB1:CF1:PVDF is 86:9:2:3. The cathode material paste was applied on an aluminum foil used as a cathode collector 1, and dried at 80° C. and pressed with a pressure roller, followed by drying at 120° C. to form the cathode electrode layer 2 on the cathode collector 1.

Subsequently, an anode material paste was prepared by using a pseudo-anisotropic carbon which is an amorphous carbon as an anode active substance, carbon black (CB2) as a conductive material, PVDF as a binder and NMP as a solvent so that the solid content weight on drying of the pseudo-anisotropic carbon:CB2:PVDF is 88:5:7. The anode material paste was applied on a copper foil used as an anode collector 4, and dried at 80° C. and pressed with a pressure roller, followed by drying at 120° C. to form the anode electrode layer 5 on the anode collector 4.

A wound electrode group was constituted by sandwiching the separator 7 between the electrodes prepared and inserted into the anode battery can 13. A wound-type lithium ion battery was prepared by further filling an electrolyte solution and caulking the open end portion of the anode battery can 13. The electrolyte solution was prepared by dissolving lithium salt LiPF₆ as an electrolyte in a mixed solvent prepared by mixing EC, DMC and EMC with a volume composition ratio of 20:40:40, in an amount of 1 mol/l, and further adding TTFP and VC each in an amount of 0.8% by weight, based on the total weight of the solution composed of the mixed solvent and lithium salt.

### Example 2

A lithium ion battery was prepared in the same manner as in Example 1 except for adding TTFP and VC in amounts of 0.4% by weight and 0.8% by weight, respectively.

### Example 3

A lithium ion battery was prepared in the same manner as in Example 1 except for adding TTFP and VC in amounts of 1.6% by weight and 0.8% by weight, respectively.

### Example 4

A lithium ion battery was prepared in the same manner as in Example 1 except for dissolving lithium salt LiPF₆ as an electrolyte in an amount of 1.2 mol/l.

### Comparative Example 1

A lithium ion battery was prepared in the same manner as in Example 1 except for adding only VC in an amount of 0.8% by weight.

### Comparative Example 2

A lithium ion battery was prepared in the same manner as in Example 1 except for dissolving lithium salt LiPF₆ as an electrolyte in an amount of 1.2 mol/l.

### Comparative Example 3

A lithium ion battery was prepared in the same manner as in Example 1 except for adding only TTFP in an amount of 0.4% by weight.

### Comparative Example 4

A lithium ion battery was prepared in the same manner as in Example 1 except for adding only TTFP in an amount of 0.8% by weight.

### Comparative Example 5

A lithium ion battery was prepared in the same manner as in Example 1 except for adding only TTFP in an amount of 1.6% by weight.

### Comparative Example 6

A lithium ion battery was prepared in the same manner as in Example 1 except for adding VC and trimethylphosphate (TMP) each in an amount of 0.8% by weight based on the total weight of a solution composed of the mixed solvent and lithium salt, in the electrolyte solution.

### Comparative Example 7

A lithium ion battery was prepared in the same manner as in Example 1 except for adding polyethylene oxide in an amount of 0.1% by weight, based on the total weight of a solution composed of the mixed solvent and lithium salt, in the electrolyte solution.

For each lithium ion battery prepared, a storage test was carried out under a high temperature environment. The storage temperature was 70° C. and the storage voltage was 4.1 V. Table 2 shows the battery capacity maintenance rate and the output power measured for the lithium ion batteries of Examples 1 to 4 and Comparative Examples 1 to 7. The battery capacity maintenance rate is the battery capacity after storage relative to the initial battery capacity. The battery capacity is determined by charging and discharging at a charge termination voltage of 4.1 V, a discharge termination voltage of 2.7 V and a charge and discharge rate of 1 C (one hour rate). Based on the battery capacity determined, the output power of SOC 50% is examined. The output power is determined by applying a current of 1 C, 5 C and 10 C to a direct current resistance for 10 seconds and measuring the voltage at the tenth second for each current value. That is, the output power is determined by the following expression: the output value=the current value×the voltage value, using the discharge termination voltage of the battery, and a current value when extrapolating a straight line of the current-voltage characteristics up to the discharge termination voltage. The output power of Comparative Example 1 in which only VC is added is shown as 100%.

TABLE 2

| | | | | Battery | |
|---|---|---|---|---|---|
| | | Amount of | | Capacity | |
| | | Additives | | Maintenance | Output |
| | | (% by | LiPF₆ | Rate | Power |
| | Additives | weight) | (mol/l) | (%) | (%) |
| Example 1 | TTFP + VC | 0.8 + 0.8 | 1.0 | 78.8 | 103.4 |
| Example 2 | TTFP + VC | 0.4 + 0.8 | 1.0 | 78.8 | 104.7 |
| Example 3 | TTFP + VC | 1.6 + 0.8 | 1.0 | 78.8 | 102.7 |
| Example 4 | TTFP + VC | 0.8 + 0.8 | 1.2 | 78.8 | 103.4 |
| Comparative | VC | 0.8 | 1.0 | 72.0 | 100.0 |
| Example 1 | | | | | |
| Comparative | VC | 0.8 | 1.2 | 71.8 | 101.2 |
| Example 2 | | | | | |
| Comparative | TTFP | 0.4 | 1.0 | 72.8 | 99.0 |
| Example 3 | | | | | |
| Comparative | TTFP | 0.8 | 1.0 | 75.0 | 94.9 |
| Example 4 | | | | | |
| Comparative | TTFP | 1.6 | 1.0 | 72.8 | 95.1 |
| Example 5 | | | | | |
| Comparative | VC + TMP | 0.8 + 0.8 | 1.0 | 69.9 | 100.5 |
| Example 6 | | | | | |
| Comparative | Polyethylene | 0.1 | 1.0 | 70.0 | — |
| Example 7 | Oxide | | | | |

As is clear from the results in Table 2, the battery capacity maintenance rate in the case of adding only TTFP is improved compared with the case of adding VC, but the output power is not improved. However, when TTFP and VC are added, the battery capacity maintenance rate and the output power are simultaneously improved, as compared with the case of adding each of TTFP and VC individually. In addition, when polyethylene oxide is added (Comparative Example 7), the battery capacity maintenance rate of the battery was 70%, and it is found that the battery performance was reduced by the addition of polyethylene oxide. Therefore, by employing the constitution of the present invention, in a lithium ion battery using an electrolyte solution prepared by dissolving a lithium salt such as LiPF₆, a protection film is formed on the anode surface to suppress the reaction between the electrolyte and the anode and to suppress the deterioration during the high temperature storage caused by the decomposition of the lithium salt, thereby consequently making it possible to obtain a lithium ion battery excellent in high temperature characteristics.

What is claimed is:

1. A lithium ion battery having a cathode capable of occluding and releasing lithium ions, an anode capable of occluding and releasing lithium ions, a separator disposed between the cathode and the anode and an organic electrolyte solution,
the organic electrolyte solution comprising a plurality of solvents, an additive and an electrolyte,
the electrolyte comprising lithium hexafluorophosphate (LiPF₆), and
the additive comprising vinylene carbonate or a derivative thereof and a compound represented by the following formula (I): 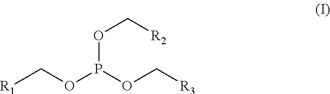
wherein R₁, R₂ and R₃ are each independently a fluorine atom or a fluorinated alkyl group having 1 to 3 carbon atoms.

2. The lithium ion battery according to claim 1, wherein the solvent comprises a cyclic carbonate represented by the following formula (II): 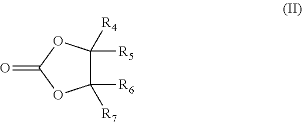
wherein R₄, R₅, R₆ and R₇ are each independently a hydrogen atom or an alkyl group having 1 to 3 carbon atoms
and a chain carbonate represented by the following formula (III):
wherein R₈ and R₉ are each independently a hydrogen atom or an alkyl group having 1 to 3 carbon atoms.

3. The lithium ion battery according to claim 2, wherein the cyclic carbonate is at least one selected from ethylene carbonate and propylene carbonate, and the chain carbonate is at least one selected from dimethyl carbonate and ethyl methyl carbonate.

4. The lithium ion battery according to claim 3, wherein the cyclic carbonate is ethylene carbonate and the chain carbonate is dimethyl carbonate and ethyl methyl carbonate.

5. The lithium ion battery according to claim 1, wherein the compound represented by the formula (I) is tris(2,2,2-trifluoroethyl)phosphite (TTFP).

6. The lithium ion battery according to claim 1, wherein the content ratio of the compound represented by the formula (I) is 0.01 parts by weight or more and 5.0 parts by weight or less, based on 100 parts by weight of the organic electrolyte solution.

7. The lithium ion battery according to claim 1, wherein the concentration of the electrolyte is 0.5 mol/l or more and 2.0 mol/l or less, based on the total amount of the solvent and the additive.

8. The lithium ion battery according to claim 1, wherein the cathode comprises a lithium transition metal oxide represented by LiMnₓM1_{y}M2_{z}O₂, wherein M1 is at least one selected from Co and Ni, M2 is at least one selected from Co, Ni, Al, B, Fe, Mg and Cr, x+y+z=1, 0.2≦x≦0.6, 0.2≦y≦0.6 and 0.05≦z≦0.4.
